(19) United States
(12) Patent Application Publication
(10) Pub. No.: US 2014/0172175 A1
(43) Pub. Date: Jun. 19, 2014

(54) HANDHELD ELECTRONIC DEVICE AND METHOD OF REMOTELY CONTROLLING HOUSEHOLD APPLIANCES USING THE HANDHELD ELECTRONIC DEVICE

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: MENG-LIANG YANG, Shenzhen (CN)

(73) Assignees: HON HAI PRECISION INDUSTRY CO., LTD., New Taipei (TW); HONG FU JIN PRECISION INDUSTRY (ShenZhen) CO., LTD.

(21) Appl. No.: 14/101,396

(22) Filed: Dec. 10, 2013

(30) Foreign Application Priority Data
Dec. 13, 2012 (CN) 2012105386273

(51) Int. Cl. G05B 15/02

(52) U.S. Cl. CPC G05B 15/02
USPC 700/275

(57) ABSTRACT

In a method to remotely control household appliances using a handheld electronic device, a power-on signal is sent to a household appliance to power on the household appliance. A model list is provided for receiving a model corresponding to the household appliance selected from the model list, and a control interface of a control software that matches to the selected model is displayed on the handheld electronic device. The household appliance, thus, can be remotely controlled according to keys selected in the control interface.

### BACKGROUND

1. Technical Field

Embodiments of the present disclosure relate to a handheld electronic device equipped with a remote control function, and more particularly, to a handheld electronic device equipped with a remote control function capable of remotely controlling household appliances.

2. Description of Related Art

In ordinary homes and offices, remote control devices are provided for each household appliance, such as televisions, audio devices, personal computers, air conditioners, lighting fixtures, and other such external devices.

Under these circumstances, the number and types of remote control devices tend to proliferate. Moreover, each remote control device operates differently, which complicates operation and causes problems in terms of operability.

### BRIEF DESCRIPTION OF THE DRAWINGS

FIG. 1 is a schematic diagram of one embodiment of an applied environment of a remote control system that remotely controls household appliances.

FIG. 2 is a block diagram of one embodiment of a handheld electronic device with the remote control system installed.

FIG. 3 is a block diagram of one embodiment of function modules of the remote control system.

FIG. 4 is a flowchart of one embodiment of a remote control method that remotely controls household appliances.

FIG. 5 is a schematic diagram of a control interface that remotely controls household appliances.

### DETAILED DESCRIPTION

In general, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processers. The modules described herein may be implemented as either software and/or hardware modules and may be stored in any type of non-transitory computer-readable storage medium or other computer storage device.

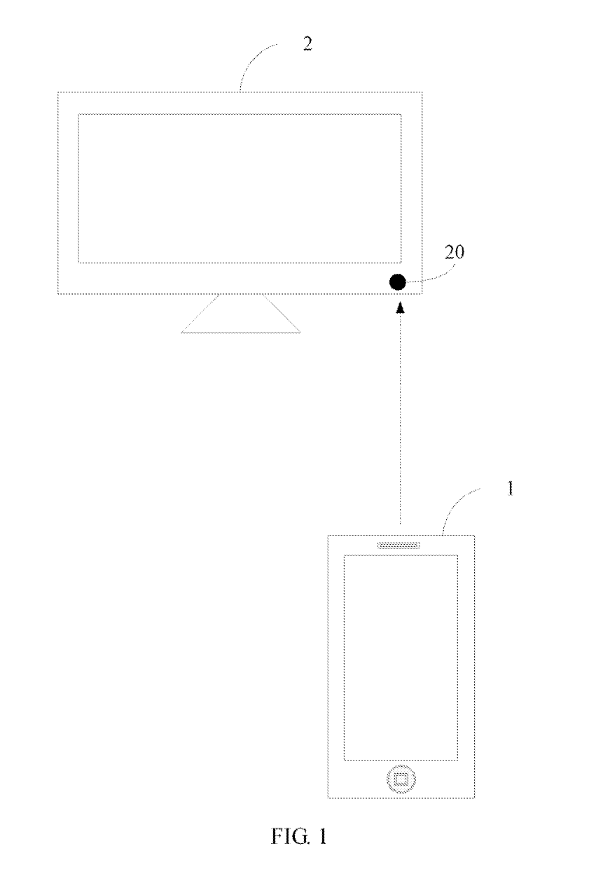

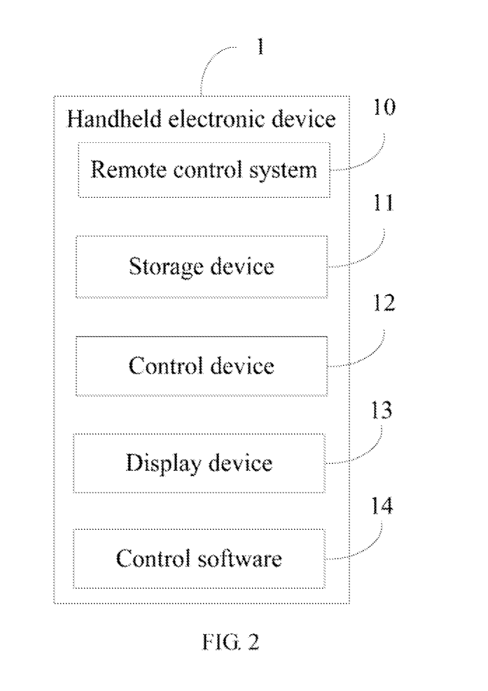

FIG. 1 is a schematic diagram of one embodiment of an applied environment of a remote control system 10 (shown in FIG. 2) that remotely controls household appliances. The remote control system 10 is applied in an environment that comprises a handheld electronic device 1 and one or more household appliances 2 (only one shown). Each of the household appliances 2 comprises a communication unit 20 that is used to communicate with the handheld electronic device 1 wireless, such as via BLUETOOTH, radio frequency identification (RFID), or infrared, for example. The handheld electronic device 1 may be a mobile phone, a portable computer, or a personal digital assistant (PDA), for example. The household appliances 2 may comprise televisions, audio devices, personal computers, or air conditioners, for example. In the following illustrated embodiments, the handheld electronic device 1 is a mobile phone, and the household appliances 2 a television is used as an illustration.

FIG. 2 is a block diagram of one embodiment of the handheld electronic device 1 with the remote control system 10 installed. The handheld electronic device 1 further comprises a storage device 11, a control device 12, and a display device 13.

In addition, the handheld electronic device 1 further has various control software installed 14 of different models of the household appliances 2 that controls functions of the household appliances 2. The functions of the household appliances 2, a television for example, comprise, such as volume adjustments, channel switches, or power on/off, for example. Each control software 14 corresponds to a model of one of the household appliances 2.

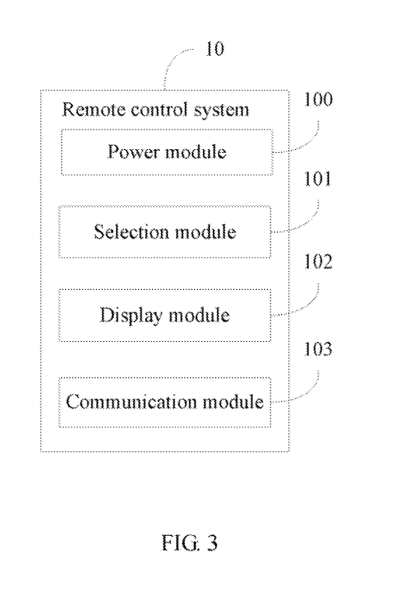

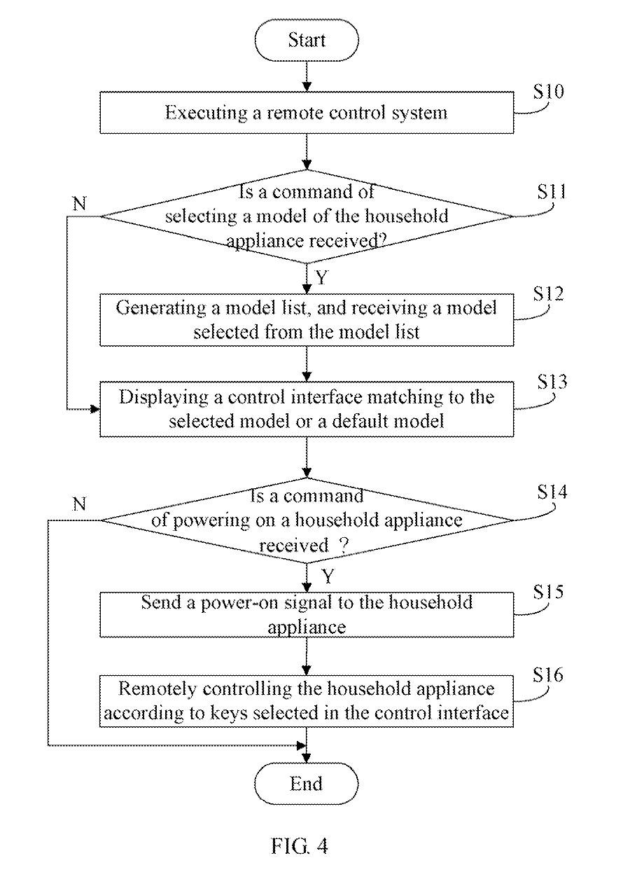

The remote control system 10 comprises a number of function modules (see FIG. 3) that include computerized codes in the form of one or more computer-readable programs that are stored in a non-transitory computer-readable storage medium (e.g., the storage device 11) and executed by at least one processor (i.e., the control device 12) of the handheld electronic device 1, and provide at least the functions needed to execute steps illustrated in FIG. 4 below.

The storage device 11 can comprise some type(s) of non-transitory computer-readable storage medium, such as a hard disk drive, a compact disc, a digital video disc, or a tape drive.

The control device 12 can comprise a processor, a microprocessor, an application-specific integrated circuit (ASIC), and a field programmable gate array, (FPGA) for example.

The display device 13 displays visible data, such as a control interface of each of the control software 14.

FIG. 3 is a block diagram of one embodiment of function modules of the remote control system 10. In one embodiment, the function modules comprises a power module 100, a selection module 101, a display module 102, and a communication module 103. Details of the functions of the function modules 100-103 are described with reference to FIG. 4.

FIG. 4 is a flowchart of one embodiment of a remote control method that remotely controls the household appliances 2. The method is executed by the control device 12 of the handheld electronic device 1. Depending on the embodiment, additional steps in FIG. 4 may be added, others removed, and the ordering of the steps may be changed.

In step S10, the remote control system 10 is executed. In one embodiment, the remote control system 10 can be executed automatically when the handheld electronic device 1 is powered on. In other embodiments, the remote control system 10 can be executed when a shortcut icon, which corresponds to the remote control system 10, located on the display device 13, is selected.

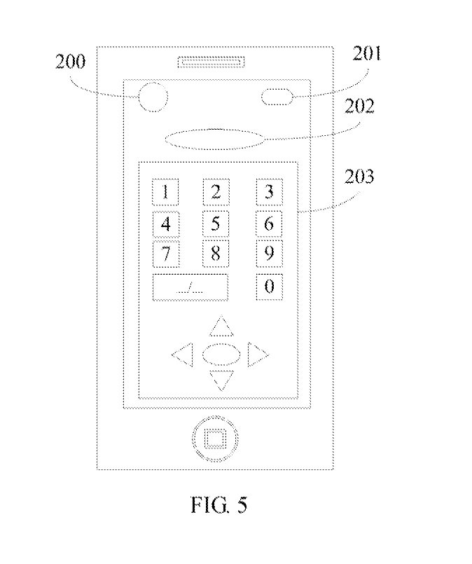

In step S11, the selection module 101 determines if a command of selecting a model of the household appliance 2 is received. As mentioned above, the household appliance 2 may be a television, an audio device, a personal computer, an air conditioner, or a lighting fixture, for example, and each of the household appliances 2, such as a television, produced by different manufactories may have a different model. Thus, a model of the household appliance 2 may need to be selected. In one embodiment, referring to FIG. 5, the handheld electronic device 1 may comprise a physical or virtual key 202, which is pressed or touched, to output a model list for selecting a model of the household appliance 2. When a model in the model list is selected, a command of selecting a model of the household appliance 2 is generated and transmitted to the selection module 101. When the selection module 101 receives a command of selecting a model of the household appliance 2, step S12 is implemented. Otherwise, when no such command is received by the selection module 101, step S13 is implemented.

In step S12, the display module 102 generates a model list, and outputs the model list on the display device 13, and receives a model selected from the model list.

In step S13, the display module 102 displays a control interface of a control software that matches to the selected model or a default model, on the display device 13. In one embodiment, when a model has been selected from the model list, the display module 102 displays a control interface matching the selected model. In another embodiment, when no model has been selected, the display module 102 displays a control interface matching the default model.

In step S14, the power module 101 determines if a command of powering on a household appliance 2 is received. In one illustrated embodiment, such as shown in FIG. 5, the handheld electronic device 1 comprises a physical or virtual key 200, which is pressed or touched, to generate a command of powering on a household appliance 2 corresponding to the selected model or the default model. When a command of powering on a household appliance 2 is received by the power module 101, step S15 is implemented. Otherwise, when no such command is received by the power module 101, the procedure ends.

In step S15, the power module 100 sends a power-on signal to a corresponding household appliance 2. As mentioned above, each of household appliances 2 comprises a communication unit 20 to receive the power-on signal. After receiving the power-on signal, the household appliance 2 is powered on.

In step S16, the communication module 103 remotely controls the household appliance 2 according to keys selected in the control interface.

FIG. 5 is a schematic diagram of a control interface of a control software that remotely controls one of the household appliances 2. As mentioned above, the control interface comprises one or more physical or virtual keys 200, each of which is pressed or touched, to generate a command of powering on one of the household appliances 2, and one or more physical or virtual keys 202, each of which is pressed or touched, to output a model list for selecting a model of the household appliance 2. The control interface may further comprise a physical or virtual key 201 that is pressed or touched to mute the volume of the household appliance 2. In addition, the control interface may further comprise an operation area 203 to adjust the volume of the household appliance 2 and switch channels of the household appliance 2.

It should be emphasized that the above-described embodiments of the present disclosure, including any particular embodiments, are merely possible examples of implementations, set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

What is claimed is:

1. A handheld electronic device that remotely controls household appliances, each of the household appliances comprising a communication unit to receive signals transmitted from the handheld electronic device, the handheld electronic device comprising:
control software of different models of the household appliances that controls functions of the household appliances;
a control device; and
a storage device storing one or more programs which when executed by the control device, causes the control device to:
generate a model list, and receive a model corresponding to the household appliance selected from the model list;
display a control interface of a control software that matches the selected model;
send a power-on signal to a household appliances corresponding to the selected model, to power on the household appliance; and
remotely control the household appliance according to keys selected in the control interface.

2. The handheld electronic device according to claim 1, wherein the handheld electronic device comprises a physical or virtual key, which is pressed or touched, generating a command corresponding to the power-on signal.

3. The handheld electronic device according to claim 1, wherein the handheld electronic device comprises a physical or virtual key, which is pressed or touched, outputting the model list.

4. The handheld electronic device according to claim 1, wherein the household appliances are televisions.

5. The handheld electronic device according to claim 4, wherein the functions of the household appliances comprise volume adjustments, channel switches, and power on/off.

6. A method of remotely controlling household appliances using a handheld electronic device, each of the household appliances comprising a communication unit to receive signals transmitted from the handheld electronic device, the handheld electronic device having control software of different models of the household appliances installed that controls functions of the household appliances, the method comprising:
generating a model list, and receiving a model corresponding to the household appliance selected from the model list;
displaying a control interface of a control software that matches to the selected model;
sending a power-on signal to one of the household appliances to power on the household appliance; and
remotely controlling the household appliance according to keys selected in the control interface.

7. The method according to claim 6, further comprising:
generating a command corresponding to the power-on signal when a physical or virtual key on the handheld electronic device is pressed or touched.

8. The method according to claim 6, further comprising:
outputting the model list when a physical or virtual key on the handheld electronic device is pressed or touched.

9. The method according to claim 6, wherein the household appliances are televisions.

10. The method according to claim 9, wherein the functions of the household appliances comprise volume adjustments, channel switches, and power on/off.

11. A non-transitory storage medium having stored thereon instructions that, when executed by processers of a handheld electronic device, causes the processers to perform a method of remotely controlling household appliances, each of the household appliances comprising a communication unit to receive signals transmitted from the handheld electronic device, the handheld electronic device having control software of different models of the household appliances installed that controls functions of the household appliances, wherein the method comprises:
generating a model list, and receiving a model corresponding to the household appliance selected from the model list;
displaying a control interface of a control software that matches to the selected model;
sending a power-on signal to one of the household appliances to power on the household appliance; and
remotely controlling the household appliance according to keys selected in the control interface.

12. The non-transitory storage medium according to claim 11, wherein the method further comprises:
generating a command corresponding to the power-on signal when a physical or virtual key on the handheld electronic device is pressed or touched.

13. The non-transitory storage medium according to claim 11, wherein the method further comprises:
outputting the model list when a physical or virtual key on the handheld electronic device is pressed or touched.

14. The non-transitory storage medium according to claim 11, wherein the household appliances are televisions.

15. The non-transitory storage medium according to claim 14, wherein the functions of the household appliances comprise volume adjustments, channel switches, and power on/off.
